(19) United States
(12) Patent Application Publication
(10) Pub. No.: US 2010/0000384 A1
(43) Pub. Date: Jan. 7, 2010

(54) Method for cutting large-size wafer and apparatus for the same

(75) Inventors: Li-chih Fang, Hsinchu (TW); Chun-Hsien Liu, Hsinchu (TW)

Correspondence Address: Cooper Legal Group LLC, 6505 Rockside Road, Suite 330, Independence, OH, 44131, US

(73) Assignee: Powertech Technology Inc., Hsinchu (TW)

(21) Appl. No.: 12/194,275

(22) Filed: Aug. 19, 2008

(30) Foreign Application Priority Data
Jul. 2, 2008 (TW) 97124953

(51) Int. Cl. B26D 3/00

(52) U.S. Cl. 83/49

(57) ABSTRACT

The present invention discloses a method for cutting a large-size wafer and an apparatus for the same. The method of the present invention decreases the frequency of wafer transmission to reduce wafer damages, wherein a wafer is always carried by an identical working susceptor, and the working susceptor is moved to the related devices performing corresponding works, or wherein a wafer is always carried by an identical working susceptor, and the related devices are moved to the working susceptor to perform corresponding works.

### BACKGROUND OF THE INVENTION

1. Field of the Invention

The present invention relates to a method for cutting a large-size wafer and an apparatus for the same, particularly to a method for cutting a wafer provided with a diameter larger than 12 inches and an apparatus for the same.

2. Description of the Related Art

After FEOL (Front End of Line) processes, the fabrication of wafers proceeds to the package process, and the dies on a wafer are singulated by cutting and then packaged. Generally, the water is transported to a grinding machine for backside grinding firstly, and the wafer will be ground to have, an appropriate thickness. Next, the wafer is mounted by an adhesive method and transported to a cutting machine for wafer cutting. In the package process, the semi-product is usually transported to the apparatuses in form of a wafer.

With the size persistently growing, the construction strength of a wafer decreases. Only a slight warpage may cause breakage in moving a wafer. Thus, how to transport a large-size wafer safely becomes a critical problem.

### SUMMARY OF THE INVENTION

One objective of the present invention is to provide a method for cutting a large-size wafer and an apparatus for the same, which decreases the frequency of wafer transmission to reduce wafer damages.

One objective of the present invention is to provide a method for cutting a large-size wafer and an apparatus for the same, wherein a wafer is fixedly carried by an identical working susceptor when processed by various devices. In other words, a wafer is always carried by an identical working susceptor, and the working susceptor carrying the wafer is moved to fabrication devices to perform fabrication steps: alternatively, a wafer is always carried by an identical working susceptor, and fabrication devices are moved to the working susceptor carrying the wafer to undertake fabrication steps.

To achieve the abovementioned objectives, one embodiment of the present invention proposes a method for cutting a large-size wafer, which comprises steps: loading a wafer on a working susceptor, wherein the active surface of the wafer is faced upward, and the wafer provided with a diameter larger than 12 inches; attaching a backside grinding tape onto the active surface of the wafer; grinding the backside of the wafer carried by the working susceptor; attaching a protective film onto the backside of the wafer; removing the backside grinding tape from the active surface of the wafer; and cutting the active surface of the wafer carried by the working susceptor to obtain a plurality of dies.

Another embodiment of the present invention proposes an apparatus for cutting a large-size wafer, which comprises a working susceptor used for carrying a wafer provided with a diameter larger than 12 inches: a first taping device moved to the working susceptor to attach a backside grinding tape onto the active surface of the wafer; a grinding device moved to the working susceptor to grind the backside of the wafer; a second taping device moved to the working susceptor to attach a protective film onto the backside of the wafer; a film-stripping device moved to the working, susceptor to remove the backside grinding tape from the active surface of the wafer; and a cutting device moved to the working susceptor to cut the active surface of the wafer to obtain a plurality of chips.

A further embodiment of the present invention also proposes an apparatus for cutting a large-size wafer, which comprises a working susceptor used for carrying a wafer provided with a diameter larger than 12 inches; a transporting device used for moving the working susceptor; a first taping device attaching a backside grinding tape onto the active surface of the wafer after the working: susceptor carrying the wafer has been moved to the first taping device; a grinding device used for grinding the backside of the wafer after the working susceptor carrying the wafer has been moved to the grinding device; a second taping device used for attaching a protective film onto the backside of the wafer after the working susceptor carrying the wafer has been moved to the second taping device; a film-stripping device, used for removing the backside grinding tape from the active surface of the wafer after the working susceptor carrying the wafer has been moved to the film-stripping device; and a cutting device used for cutting the active surface of the wafer to obtain a plurality of dies after the working susceptor carrying the wafer has been moved to the cutting device.

### BRIEF DESCRIPTION OF THE DRAWINGS

FIG. 1 is a flowchart of a method for cutting a large-size wafer according to one embodiment of the present invention;

FIG. 2 is a diagram schematically showing an apparatus for cutting a large-size wafer according to one embodiment of the present invention;

FIG. 3 is a diagram schematically showing an apparatus for cutting a large-size wafer according to one embodiment of the present invention;

FIG. 4 is a diagram schematically showing an apparatus for cutting a large-size wafer according to one embodiment of the present invention; and

FIG. 5 is a diagram schematically showing an apparatus for cutting a large-size wafer according to one embodiment of the present invention.

### DETAILED DESCRIPTION OF THE INVENTION

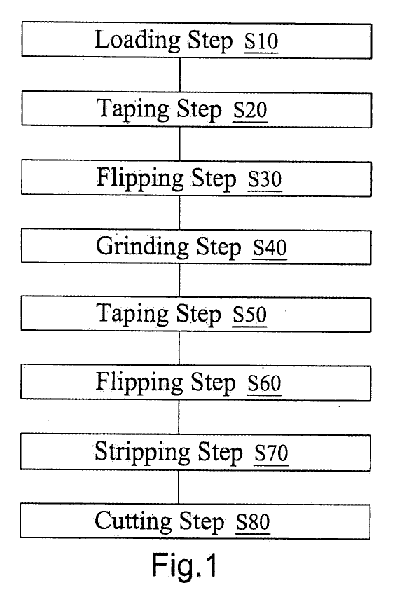

Referring to FIG. 1, in one embodiment of a method for cutting a large-size wafer, a wafer is loaded on a working susceptor firstly (S10, a loading step). The active surface of the wafer faces upward, and the wafer provides with a diameter larger than 12 inches, for example 18 inches. Next, a backside grinding tape is attached onto the active surface of the wafer (S20, a taping step). Next, the wafer is flipped over to let the backside face upward (S30, a flipping step). Next, the backside of the wafer carried by the working susceptor is grinded (S40, a grinding step). Next, a protective film is attached onto the backside of the wafer (S50, a taping step). Next, the wafer is flipped over to let the active surface upward (S60, a flipping step). Next, the backside grinding tape is stripped away from the active surface of the wafer (S70, a stripping step). Next, the active surface of the wafer carried by the working susceptor is cut to obtain a plurality of dies (S80, a cutting step). In the present invention, the wafer is not moved away from the working susceptor but always carried by the identical working susceptor until obtaining a plurality of dies.

In one embodiment, at the grinding step, a grinding device is moved to the Working susceptor, or the working susceptor is moved to a grinding device. Similarly, at the taping step of attaching the backside grinding tape or the protective film, a taping device is moved to the working susceptor, or the working susceptor is moved to a taping device to attach the backside grinding tape or the protective film. Besides, at the cutting step, a cutting device is moved to the working susceptor, or the working susceptor is moved to a cutting device.

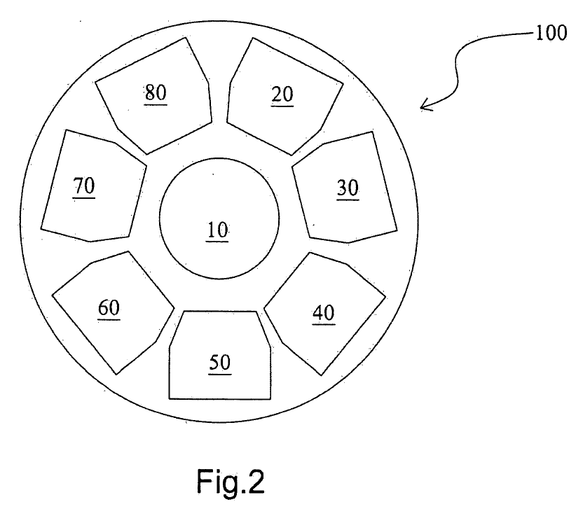

Referring to FIG. 2, in one embodiment, the apparatus for cutting a large-size wafer comprises a working susceptor 10, a first taping device 20, a grinding device 40, a second taping device 50, a film-stripping device 60, and a cutting device 70.

In the embodiment, the working susceptor 10 is used for carrying a wafer provided with a diameter larger than 12 inches. The first taping device 20 is moved to the working susceptor 10 to attach a backside grinding tape onto the active surface of the wafer. In one embodiment, the apparatus of the present invention further comprises a wafer-flipping device 30 used for flipping over the wafer to let the active surface downward. The grinding device 40 is moved to the working susceptor 10 to grind the backside of the wafer. The second taping device 50 is moved to the working susceptor 10 to attach a protective film onto the backside of the wafer. Then, the wafer is flipped over again to let the active surface upward, and the film-stripping device 60 is moved to the working susceptor 10 to strip the backside grinding tape away from the active surface of the wafer. Then, the cutting device 70 is moved to the working, susceptor 10 to cut the active surface to obtain a plurality of dies.

As some devices can perform their works without flipping over the wafer, the present invention is not limited to having to use a wafer flipping device. In the present invention, a robot arm is used for moving the first taping device 20, the wafer-flipping device 30, the grinding device 40, the second taping device 50, the film-stripping device 60 and the cutting device 70 to the working susceptor 10 to perform their works. Besides, the robot arm may also move other devices 80 to the working susceptor 10 to perform related works, if necessary.

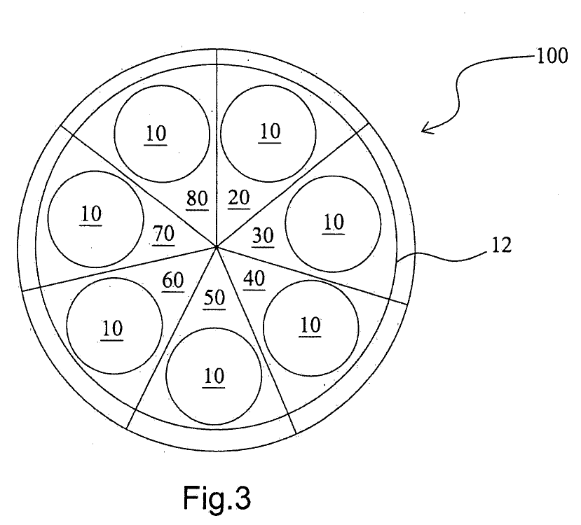

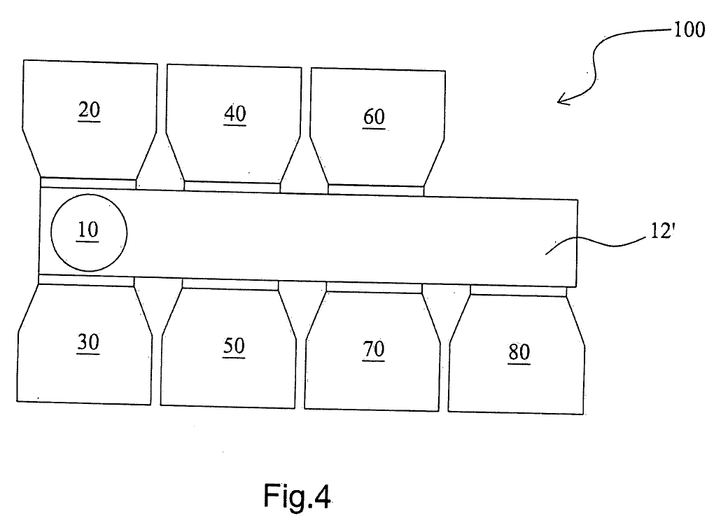

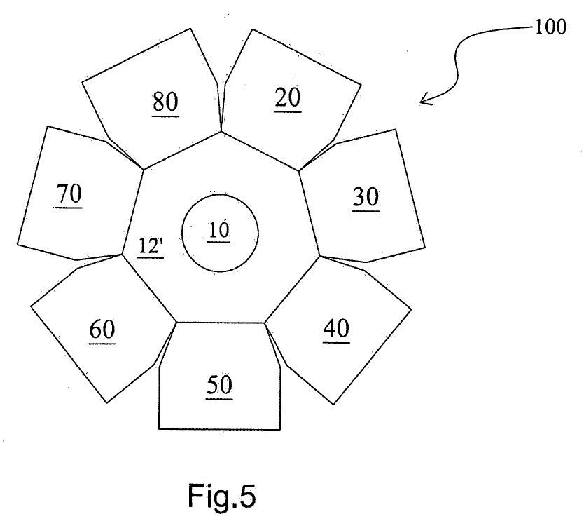

Referring to FIG. 3, in one embodiment, a transporting device transports the working susceptor 10 to the devices to perform related works of wafer cutting. The transporting device may be a turn table 12. The working susceptors 10 are placed on the rum table 10 and moved by the turn table 12. Thereby, the apparatus for cutting a large-size wafer of the present invention can continuously perform the cutting process and promote the productivity. In one embodiment, the transporting device is a caterpillar band 12′. Referring to FIG. 4, in one embodiment, the first taping device 20, the wafer-flipping device 30, the grinding device 40, the second taping device 50, the film-stripping device 60 and the cutting device 70 are arranged in line. Referring to FIG. 5, in one embodiment, the first taping device 20, the wafer-flipping device 30, the grinding device 40, the second taping device 50, the film-stripping device 60 and the cutting device 70 are arranged in cluster. Obviously, the method and apparatus for cutting a large-size wafer of the present invention also contain appropriate steps and devices to isolate and clean process residues lest wafers be polluted.

In conclusion, the present invention decreases the frequency of wafer relocations to reduce wafer damages, wherein a wafer is always carried by an identical working susceptor, and the working susceptor is moved to the related devices performing corresponding works, or wherein a wafer is always carried by an identical working susceptor, and the related devices are moved to the working susceptor to perform corresponding works.

The embodiments described above are to demonstrate the technical contents and characteristics of the preset invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A method for cutting a large-size wafer, comprising:
loading a wafer on a working susceptor, wherein an active surface of said wafer is upward, and a diameter of said wafer is larger than 12 inches;
attaching a backside grinding tape onto said active surface of said wafer;
grinding said backside of said wafer carried by said working susceptor;
attaching a protective film onto said backside of said wafer;
stripping said backside grinding tape away from said active surface of said wafer; and
cutting said active surface of said wafer carried by said working susceptor to obtain a plurality of dies.

2. The method for cutting a large-size wafer according to claim 1 further comprising a step of moving said working susceptor to a grinding device performing said grinding step, or moving said grinding device to said working susceptor to perform said grinding step.

3. The method for cutting a large-size wafer according to claim 1 further comprising a step of moving said working, susceptor to a cutting device performing said cutting step, of moving said cutting device to said working susceptor to perform said cutting step.

4. The method for cutting a large-size wafer according to claim 1 further comprising a step of moving said working susceptor to a taping device attaching said backside grinding tape, or moving said taping device to said working susceptor to attach a backside grinding tape.

5. The method for cutting a large-size wafer according to claim 1 further comprising a step of moving said working susceptor to a second taping device attaching said protective film, or moving said second taping device to said working susceptor to attach said protective film.

6. The method for cutting a large-size wafer according to claim 1 further comprising a step of flipping over said wafer to make said backside of said wafer face upward before said grinding step.

7. The method for cutting a large-size wafer according to claim 6 further comprising a step of flipping over said wafer to make said active surface of said wafer face upward before said stripping step.

8. An apparatus for cutting a large-size wafer comprising
a working susceptor used for carrying a wafer provided with a diameter larger than 12 inches:
a first taping device moved, to said working susceptor to attach a backside grinding tape onto an active surface of said wafer;
a grinding device moved to said working susceptor to grind a backside of said wafer;
a second taping device moved to said working susceptor to attach a protective film onto said backside of said wafer;
a film-stripping device moved to said working susceptor to strip said backside grinding tape away from said active surface of said wafer; and
a cutting device moved to said working susceptor to cut said active surface of said wafer to obtain a plurality of chips.

9. The apparatus for cutting a large-size wafer according to claim 8 further comprising a wafer-flipping device used for flipping over said wafer.

10. The apparatus for cutting a large-size wafer according to claim 9 further comprising a robot arm used for moving said first taping device, said wafer-flipping device, said grinding device, said second taping device, said film-stripping device and said cutting device to said working susceptor.

11. An apparatus for cutting a large-size wafer comprising
a working susceptor used for carrying a wafer provided with a diameter larger than 12 inches;
a transporting device used for moving said working susceptor;
a first taping device used for attaching a backside grinding tape onto an active surface of said wafer after said working susceptor carrying said wafer has been moved to said first taping device;
a grinding device used for grinding a backside of said wafer after said working susceptor carrying said wafer has been moved to said grinding device;
a second taping device, used for attaching a protective film onto said backside of said wafer after said working susceptor carrying, said wafer has been moved to said second taping device;
a film-stripping device used for stripping said backside grinding tape away from said active surface of said wafer after said working susceptor carrying said wafer has been moved to said film-stripping device; and
a cutting device used for cutting said active surface of said wafer to obtain a plurality of dies after said working susceptor carrying said wafer has been moved to said cutting device.

12. The apparatus for cutting a large-size wafer according to claim 11, wherein said transporting device is a turn table or a caterpillar band.

13. The apparatus for cutting a large-size wafer according to claim 12 further comprising a wafer-flipping device used for flipping over said wafer carried by said working susceptor.
